(19) United States
(12) Patent Application Publication
(10) Pub. No.: US 2008/0115989 A1
(43) Pub. Date: May 22, 2008

(54) DIESEL ENGINE VEHICLE CONFIGURATIONS FOR EVACUATION OF ENGINE AND/OR EXHAUST SYSTEM HEAT

(76) Inventors: Francois MATTE, Quebec (CA); Marc RIEDL, Levis (CA)

Correspondence Address: OGILVY RENAULT LLP, 1981 MCGILL COLLEGE AVENUE, SUITE 1600, MONTREAL, QC, H3A2Y3, omitted

(21) Appl. No.: 11/943,124

(22) Filed: Nov. 20, 2007

Related U.S. Application Data
(60) Provisional application No. 60/866,500, filed on Nov. 20, 2006.

(51) Int. Cl. B60H 1/03; B60H 1/26; B60K 11/06; F01N 3/023

(52) U.S. Cl. 180/68.1; 454/164; 60/295; 60/320

(57) ABSTRACT

The diesel engine vehicle has a passenger area, and a substantially vertically oriented ventilated chamber separate from the passenger area. The ventilated chamber can be in air flow communication with an engine compartment to evacuate heat therefrom. A heat-emitting exhaust treatment unit can be housed in the ventilated chamber and connected between the diesel engine and an exhaust outlet in an exhaust system of the vehicle.

### CROSS-REFERENCE TO RELATED APPLICATIONS

This application claims priority of U.S. Provisional Patent Application No. 60/866,500, filed Nov. 20, 2006, the contents of which are hereby incorporated.

### FIELD

This specification relates to the field of diesel engine vehicles, such as coaches and motor homes for example, and more specifically teaches configurations thereof which allow evacuation of heat from the engine compartment and/or from the exhaust system.

### BACKGROUND

Large diesel engine vehicles typically have proportionally large diesel engines, which can emit substantial quantities of heat. Further, in many such vehicles, and perhaps coaches and motor homes in particular, there is a strong incentive related to increasing the amount of internal space available for passengers or luggage. This imposes much restriction in the amount of internal space allotted to housing engine or exhaust system components, let alone internal space allotted to managing heat evacuation of the relatively large engines. In coaches, to gain passenger or luggage space, the engine is typically enclosed in a relatively small and difficult to ventilate engine compartment at the rear end of the vehicle. A relatively important portion of heat evacuation is managed by using a relatively large engine radiators, the size of which make them relatively costly devices.

There is thus a need in the art of diesel engine vehicles in general, and coaches and motor homes in particular, for improvements to previously known engine or exhaust heat evacuation management techniques or configurations.

In accordance with another aspect, the importance of exhaust gas treatment units in exhaust systems of diesel engine vehicles has considerably increased during past years, much with the trend to obtain “cleaner” emissions or “greener” vehicles. Diesel particle filters, or DPFs, which can reduce particulate emissions, and selective catalytic reduction units, or SCRs, which can reduce NOx emissions, are two examples of exhaust gas treatment units which can be used with diesel engine vehicles.

As can be understood from the above discussion, there is a considerable drawback of some exhaust gas treatment units which is related to the fact that they can emit a relatively large amount of heat. The consideration of their use imposes an additional burden with respect to heat management. Diesel particle filters (DPFs), for instance, accumulate particulate matter or soot. To get rid of the accumulated matter in the particle filter, a process referred to as filter regeneration can be used. Heat regeneration is a commonly used filter regeneration technique which involves increasing the temperature of the accumulated particles until they ignite or combust. The increase of temperature can be caused for example by a fuel burner, or through engine management techniques which cause the exhaust gasses to reach predetermined burning temperatures. The resulting increase in temperature can be felt in the exhaust gasses themselves, in the components of the exhaust system, and in the environment of the exhaust system, and imposes an additional challenge with respect to heat evacuation.

In the case of diesel engine truck tractors, for instance, diesel particle filters (DPF's), are typically positioned externally, outside of the truck cabin, where the heat can be evacuated relatively directly to the atmosphere. It will be understood that this can render the external appearance of the vehicle unacceptably unattractive in certain applications, or thereagain unsatisfactorily affect the aerodynamics of the vehicle. Enclosing heat-emitting exhaust treatment units was not envisaged because of the implied restrictions to heat evacuation which were deemed unsolvable in certain applications.

There is thus a strong need felt in the art to solve the problems related with using heat-emitting exhaust gas treatment units in diesel engine vehicles. This need is particularly felt in diesel engine vehicles which have restrictions with respect to visual appearance and/or available internal space.

Turning now to still another aspect, it is desired in many instances to control the temperature at which exhaust gasses are exhausted into the atmosphere, and to maintain the temperature of exhaust gasses below certain thresholds at given distances from the vehicle, to alleviate the impact of exhaust heat on the vehicle's immediate environment. Dealing with the heat generated in the exhaust gasses during heat regeneration can thus pose an important design challenge in certain types of vehicles.

These above described needs remained to be addressed.

### SUMMARY

The instant specification teaches the use of a ventilation conduit, or ventilation shaft, being oriented substantially vertically above the engine compartment and allowing the evacuation of engine heat through an aperture defined in the roof of the vehicle.

The instant specification also teaches positioning components of a vehicle exhaust system, which can include a heat-emitting exhaust treatment unit for example, in a ventilated compartment extending substantially vertically inside the vehicle. The vehicle exhaust system can have an outlet in an upper portion of the vehicle, such as through the roof, for instance.

The instant specification also teaches an exhaust gas diffuser which can be used to provide an exhaust outlet at the roof of the vehicle, and which can contribute to control the temperature which is reached by the exhaust gasses at a given distance from the vehicle.

In accordance with one aspect, there is provided a diesel engine vehicle having a wheeled body with a front end, a rear end, and a roof, the vehicle having an engine compartment inside the body, at a lower portion thereof, and a ventilation conduit extending substantially vertically inside the body, above the engine compartment, and connecting the engine compartment to a ventilation outlet in the roof, for evacuating heat from the engine compartment to the atmosphere.

In accordance with another aspect, there is provided a diesel engine vehicle having a wheeled body with a front end, a rear end, and a roof, the vehicle having a diesel engine housed in an engine compartment positioned inside the body, at a lower portion thereof, the engine having an exhaust system, the exhaust system having a heat-emitting exhaust treatment unit at least partially housed within a chamber which extends substantially vertically inside the body, above the engine compartment, a thermally insulated partition separating the chamber from a passenger compartment of the vehicle, the exhaust system having an exhaust outlet leading to the atmosphere in an upper portion of the body, and the chamber having a ventilation outlet open to the atmosphere in the upper portion of the body.

In accordance with another aspect, there is provided a diesel engine vehicle having a passenger area, and a chamber partitioned from the passenger area at a rear end of the vehicle, the diesel engine vehicle comprising a vertically-oriented heat-emitting exhaust treatment unit positioned in the chamber and connected between the diesel engine and an exhaust port.

### DESCRIPTION OF THE FIGURES

FIG. 1 is a side elevation view of a rear portion of a diesel engine vehicle;

FIG. 2 is left side perspective view of the vehicle of FIG. 1, partly sectioned to show an exhaust system chamber;

FIG. 3 is an inside perspective view of the of the exhaust system chamber of FIG. 2;

FIG. 4 is a cross-sectional view taken along lines 4-4 of FIG. 1; and

FIG. 5 is an enlarged view taken along lines 5-5 in FIG. 4.

### DETAILED DESCRIPTION

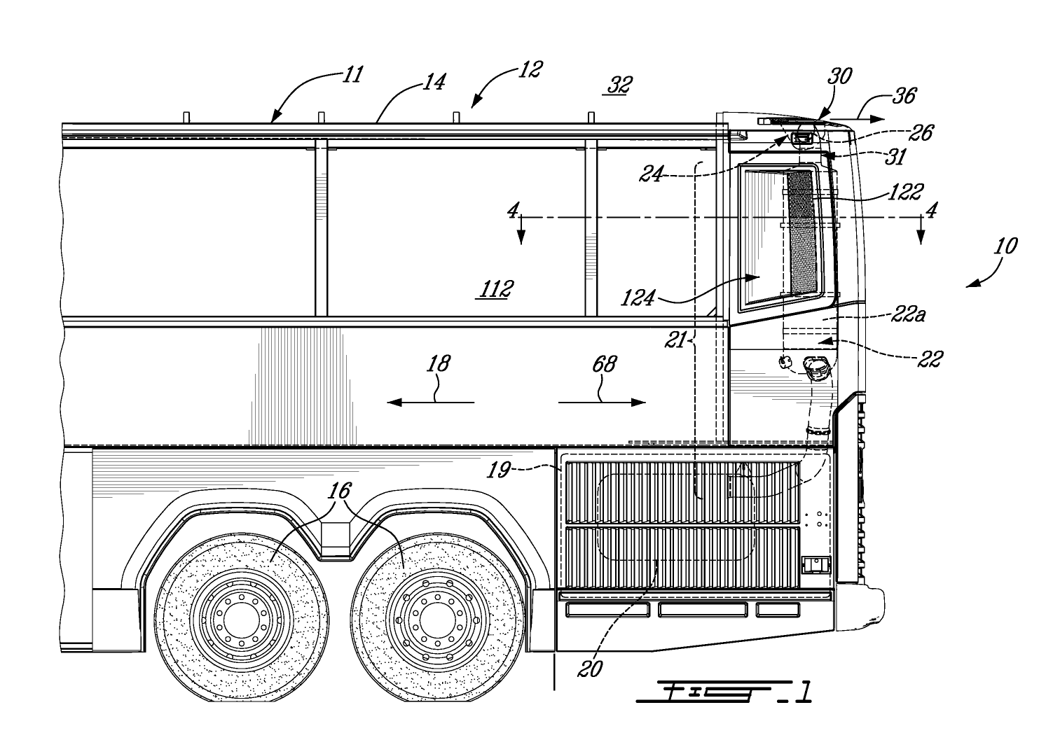

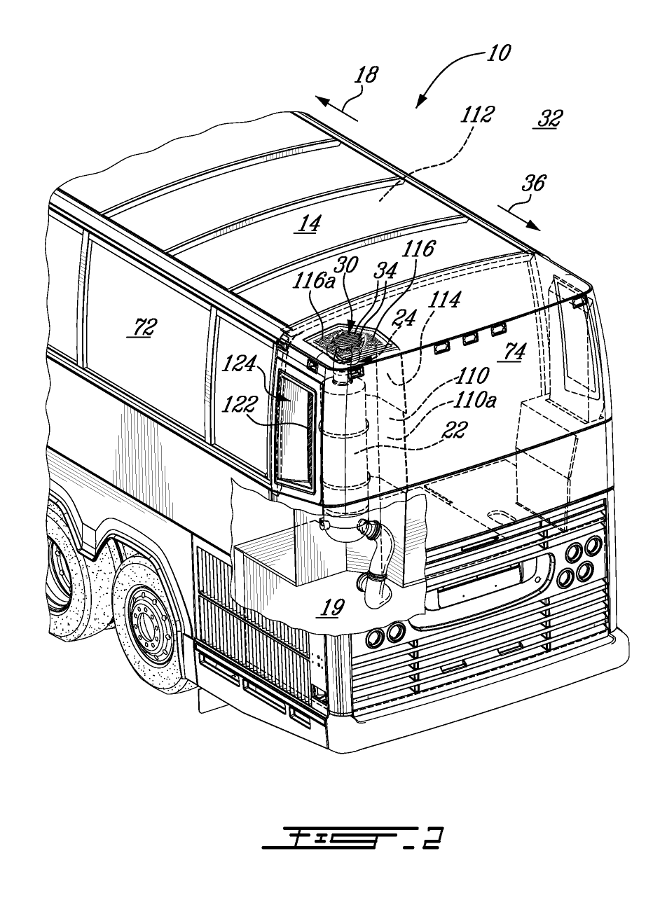

FIGS. 1 and 2 show an example of a diesel engine vehicle 10. In this example, the diesel engine vehicle 10 can be adapted for use as a passenger coach or as a motor home, for example. Only the rear portion 12 of the vehicle 10 is illustrated. The vehicle 10 generally has a wheeled body 11 having a roof 14, and wheels 16, and is designed to normally operate in a forward direction 18. The vehicle 10 also has a diesel engine 20 which is housed in an engine compartment 19 in a lower portion of the rear end of the vehicle 10. The diesel engine 20 has an exhaust system 21. The exhaust system 21 includes a exhaust gas treatment unit 22. In this example, the exhaust gas treatment unit 22 is a diesel particle filter 22a which is designed for heat-regeneration. The exhaust gas treatment unit 22 receives exhaust gasses from the engine 20, and has an upwardly extending outlet pipe 31.

In this example, a diffuser 24 is connected to the outlet pipe 31 and is used to maintain the temperature of the exhaust gasses below a given threshold at a given distance from the roof 14. The diffuser 24 has a diffuser inlet 26 connected to the exhaust gas treatment unit 22 via the pipe 31, and a diffuser outlet 30 leading to the ambient atmosphere 32 (see also FIG. 2). In this example, the diffuser outlet 30 is substantially flat and aligned with the roof 14 of the vehicle, and is equipped with vanes 34 which guide exhausting gasses in a direction partially aligned with the roof 14, and partially oriented towards the rear 36. In this example, the diffuser outlet 30 arrives flush with the generally horizontal surface of the roof 14. It does not significantly protrude from it, and is thus relatively not visually apparent from the ground.

FIG. 2 shows the exhaust gas treatment unit 22 positioned in a substantially vertically oriented chamber 110 which extends above the engine compartment 19. The chamber 110 can be partitioned from a passenger compartment 112 of the vehicle by a thermally insulated partition 114. The acoustic insulation can also be provided in the partition 114 if desired. The vertically oriented chamber 110 has a ventilation outlet 116 positioned in the roof 14 of the vehicle. In this example, the ventilation outlet 116 has an apertured grate 116a which is positioned partially around the vaned diffuser outlet 30. Heat emanated by the exhaust treatment unit 22 can thus be evacuated upwardly along the vertically oriented chamber 110, and through the ventilation outlet 116 to the atmosphere 32 in a chimney-like effect.

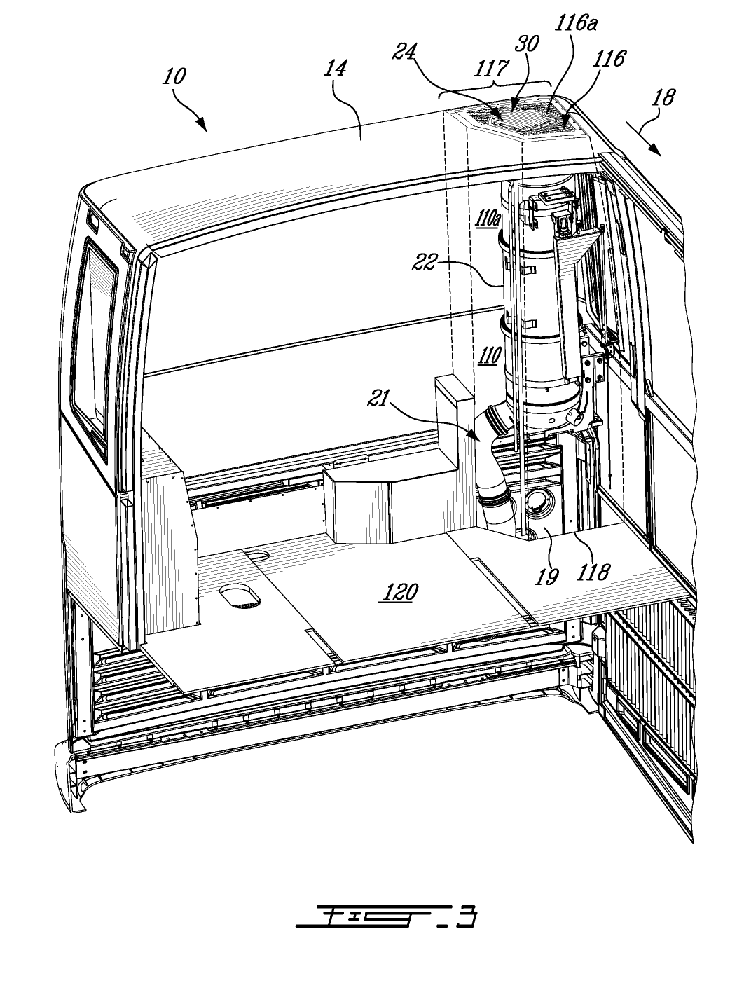

FIG. 3 shows the chamber 110 from the inside, in a fragmented view where the partition (114, FIG. 2) has been made invisible. An opening 118 can be seen in the floor 120, through which the exhaust system 21 extends upwardly. In this example, this opening 118 also connects the chamber 110 to the engine compartment 20, which allows heat from the engine compartment 20 to also be evacuated upwardly in the chimney-like effect. In this example, the chamber 110 can thus be described as a ventilation conduit 110a, or cooling duct, which allows heat from the exhaust system 21 and the engine compartment 20 to be evacuated upwardly by natural convection.

One can see that the area 117 of the roof 14 which is allotted to heat evacuation is shared between the diffuser outlet 30, through which exhaust gasses are evacuated, and the ventilation outlet 116, through which hot air from the chamber 110 is evacuated, during use. In applications such as the one illustrated, where the available roof area is limited, there can be a question of optimizing the ratio of the relative areas occupied by both outlets 30, 116. For instance, allotting more area to the diffuser outlet 30 can allow using a larger diffuser 24, which can contribute to reduce the exhaust gas temperatures at a given distance from the diffuser outlet 30, to a certain extent. However, the consequent reduction in the area of the ventilation outlet 116 can have a limiting effect on the heat evacuation from the chamber 110. Therefore, a compromise can have to be made between these two concurrent needs. For illustrative purposes, a ratio of diffuser outlet area to ventilation outlet area of about 1:1 is used in the example detailed above and illustrated, and this ratio allowed to obtain both a satisfactory evacuation of heat from the compartment 110 and satisfactorily low exhaust gas temperatures at a given distances from the diffuser outlet 30. However, other ratios can be used as well, and this question may not be relevant at all in certain alternate applications where the available roof area is not restricted.

Referring back to FIGS. 1 and 2, the chamber 110 can also be seen to have a ventilation inlet 122 through the side wall 72 of the vehicle 10. When the vehicle 10 is stationary, air can be aspired in the chamber 110 by natural convection through the engine compartment 20. Hot air can be evacuated through the ventilation outlet 116, and can also be evacuated through the ventilation inlet 122, especially in the upper portion thereof.

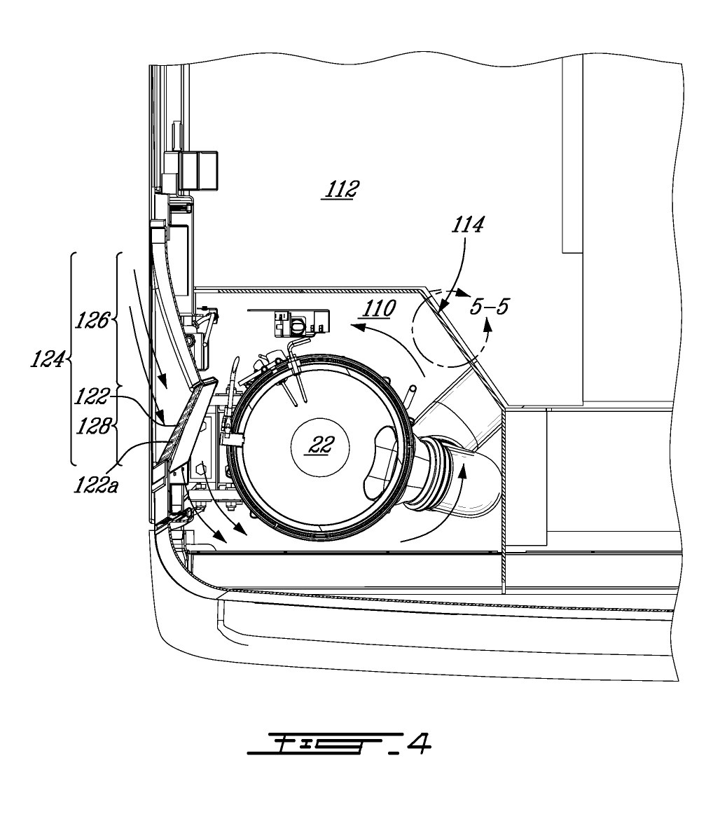

In this example, the ventilation inlet 122 is provided in a ventilation inlet panel 124. The ventilation inlet panel 124 is shaped to define a recess relative to the side wall 72 of the of the vehicle 10. This recessed shape is particularly apparent in the cross-sectional view of FIG. 4, for example.

Referring now to FIG. 4, the ventilation panel 124 includes a forward portion 126 and a rear portion 128. The forward portion 126 is somewhat inwardly curved, and the rear portion 128 has the ventilation inlet 122, which is provided as a flat apertured grate 122a in this case.

When the vehicle travels at cruising speeds, air outside the chamber is relatively turbulent, and the relatively speed at which the incoming air impinges against the ventilation inlet 122 can suffice to create a relatively strong draft inside the chamber and effectively cool down the exhaust treatment unit 22 contained therein.

Perhaps the worst conditions in terms of heat evacuation difficulty occur when the vehicle 10 is traveling at relatively low or moderate speeds, when the vehicle 10 is going uphill or carrying or towing a heavy load, for example. The illustrated ventilation panel 124 was thus designed with a particular intent to address ventilation in such conditions. At low or moderate speeds, the air flow alongside the vehicle 10, outside the chamber, can still have a relatively important component of laminar flow. With this in mind, the inwardly curved front portion 126 of the ventilation panel 124 was specifically designed to at least partially maintain the laminar characteristics of the air flow, with a curve strong enough to guide the air through the ventilation inlet 122, but at the same time, sufficiently straight to reduce the likelihood of the occurrence of an aerodynamic stall condition, in which the air can become strongly turbulent. This can thus contribute to allow a greater flow rate of cooling air into the ventilation inlet 122, especially when the vehicle 10 is travelling at low or moderate speeds.

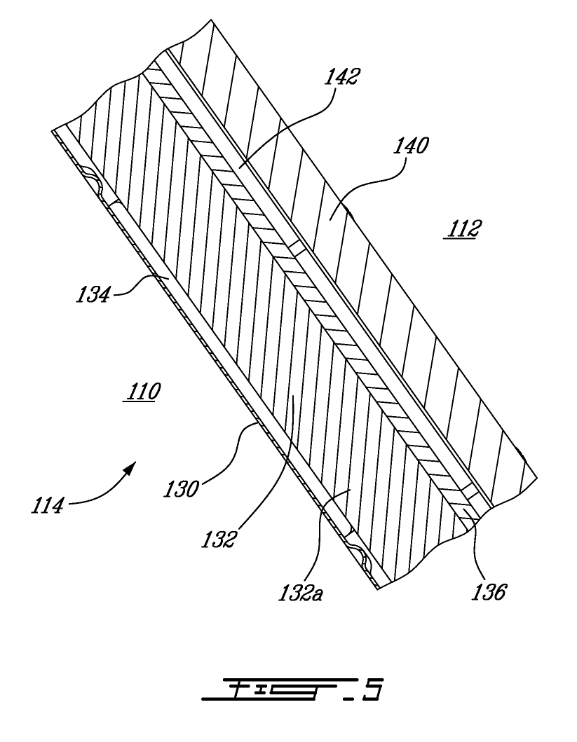

Because of the heat and noise which can be present in the chamber 110, it can be advantageous to use an insulated partition 114 to separate the chamber 110 from the passenger compartment 112. An example of such a partition 114 is depicted in FIG. 5. In this example, the partition 114 includes a steel sheet 130 which faces the chamber 110. A thermally insulating component 132 such as a thermally-resistant expanded polyurethane board 132a or any other suitable material is present behind the steel sheet 130, and is separated from the steel sheet 130 by an air spacing 134. Optionally, an acoustic insulation component 136 such as a low-density fiberboard panel or other suitable material, is used in the assembly. The acoustic insulation 136 is provided behind the thermal insulation 132 in this case. In this example, a plywood board 140 is also used behind the acoustic insulation component 140, with an air gap 142 left therebetween, although this component is entirely omitted in certain alternate applications.

The example described above and illustrated having been given for illustrative purposes only, alternate embodiments can depart from this example.

For instance, the heat-emitting exhaust treatment unit can be absent in certain applications, or alternately, two or more heat-emitting exhaust treatment units can be used in succession in the exhaust system, and can be individually positioned in the ventilated conduit or not. The heat-emitting exhaust treatment units can include a diesel particle filter, a selective catalytic converter or other NOx treatment unit, or a unit which treats other emissions, such as CO₂, for example.

The ventilation inlet can be omitted, or can be substituted by an inlet having a shape different that the one illustrated in the attached figures in alternate applications. It can also be provided on the rear wall of the vehicle, for example.

Further, the diffuser can be omitted in certain applications and the exhaust system can have a diffuser-less exhaust gas outlet.

The ventilation outlet can be provided on a wall of the vehicle instead of on the roof. It can completely surround the exhaust gas outlet, only partially surround it, or be positioned adjacent to it, for example. The exhaust gas outlet can also be provided on a side or rear wall of the vehicle if desired.

The configurations taught herein can be incorporated to any appropriate diesel engine vehicle and is not limited to bus, motor home, and coach applications.

Many other variants are also possible.

As can be seen therefore, the embodiments described above and illustrated are intended to be exemplary only. The scope is indicated by the appended claims.

What is claimed is:

1. A diesel engine vehicle having a wheeled body with a front end, a rear end, and a roof, the vehicle having an engine compartment inside the body, at a lower portion thereof, and a ventilation conduit extending substantially vertically inside the body, above the engine compartment, and connecting the engine compartment to a ventilation outlet in the roof, for evacuating heat from the engine compartment to the atmosphere.

2. The diesel engine vehicle of claim 1 wherein the engine has an exhaust system extending at least partially in the ventilation conduit and having an exhaust outlet in the roof, the ventilation outlet being at least partially around the exhaust outlet.

3. The diesel engine vehicle of claim 2 wherein the exhaust system has a diffuser having the exhaust outlet, the diffuser being positioned below the roof.

4. The diesel engine vehicle of claim 2 wherein the exhaust system includes a heat-emitting exhaust treatment unit at least partially housed within the ventilation conduit

5. The diesel engine vehicle of claim 4 wherein the exhaust treatment unit is a heat-regenerator diesel particle filter.

6. The diesel engine vehicle of claim 1 wherein the ventilation conduit has ventilation inlet defined through a side wall of vehicle.

7. The diesel engine vehicle of claim 6 wherein the ventilation inlet is configured and adapted to receive external air during displacement of the vehicle.

8. The diesel engine vehicle of claim 7 wherein the ventilation inlet has an inwardly curved front portion aerodynamically designed to impede aerodynamic stall conditions at low or moderate speeds of the vehicle.

9. The diesel engine vehicle of claim 1 wherein the ventilation conduit is partitioned from the passenger compartment of the vehicle by a thermally insulated and heat-resistant partition.

10. A diesel engine vehicle having a wheeled body with a front end, a rear end, and a roof, the vehicle having a diesel engine housed in an engine compartment positioned inside the body, at a lower portion thereof, the engine having an exhaust system, the exhaust system having a heat-emitting exhaust treatment unit at least partially housed within a chamber which extends substantially vertically inside the body, above the engine compartment, a thermally insulated partition separating the chamber from a passenger compartment of the vehicle, the exhaust system having an exhaust outlet leading to the atmosphere in an upper portion of the body, and the chamber having a ventilation outlet open to the atmosphere in the upper portion of the body.

11. The diesel engine vehicle of claim 10 wherein the chamber communicates with the engine compartment to allow heat evacuation from the engine compartment to the ventilation outlet.

12. The diesel engine vehicle of claim 10 wherein the ventilation outlet is in roof of the vehicle.

13. The diesel engine vehicle of claim 12 wherein the exhaust outlet in also defined in the roof of the vehicle, and is at least partially surrounded by the ventilation outlet.

14. The diesel engine vehicle of claim 13 wherein the exhaust system has a diffuser having the exhaust outlet, the diffuser being positioned below the roof.

15. The diesel engine vehicle of claim 10 wherein the exhaust treatment unit is a heat-regenerator diesel particle filter.

16. The diesel engine vehicle of claim 10 wherein the chamber has a ventilation inlet defined through a side wall of vehicle.

17. The diesel engine vehicle of claim 16 wherein the ventilation inlet is configured and adapted to receive external air during displacement of the vehicle.

18. The diesel engine vehicle of claim 17 wherein the ventilation inlet has an inwardly curved front portion aerodynamically designed to favor a substantially laminar flow of air into the chamber at low to moderate traveling speeds.

19. The diesel engine vehicle of claim 10 wherein the ventilation conduit is partitioned from the passenger compartment of the vehicle by a thermally insulated and heat-resistant partition.

20. A diesel engine vehicle having a passenger area, and a chamber partitioned from the passenger area at a rear end of the vehicle, the diesel engine vehicle comprising a vertically-oriented heat-emitting exhaust treatment unit positioned in the chamber and connected between the diesel engine and an exhaust port.

21. The diesel engine vehicle of claim 20 wherein the chamber has a ventilation outlet at least partially surrounding the exhaust port.

22. The diesel engine vehicle of claim 20 wherein the chamber is in air flow communication with an engine compartment housing the diesel engine.

23. The diesel engine vehicle of claim 20 wherein the chamber has a ventilation inlet defined through a side wall of the vehicle, the ventilation inlet being configured and adapted to catch the air being displaced alongside the vehicle when the vehicle is in forward operation.
